(19) United States
(12) Patent Application Publication
(10) Pub. No.: US 2018/0299813 A1
(43) Pub. Date: Oct. 18, 2018

(54) IMAGE FORMING APPARATUS AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Noboru FURUYAMA, Odawara (JP)

(73) Assignees: KABUSHIKI KAISHA TOSHIBA, Tokyo (JP); TOSHIBA TEC KABUSHIKI KAISHA, Tokyo (JP)

(21) Appl. No.: 15/686,958

(22) Filed: Aug. 25, 2017

(30) Foreign Application Priority Data
Apr. 14, 2017 (JP) 2017-080986

(51) Int. Cl. G03G 15/00

(52) U.S. Cl. CPC G03G 15/5029; G03G 15/2028

(57) ABSTRACT

An image forming apparatus includes a print speed determination section and a print speed control section. The print speed determination section determines, on the basis of at least one of a shape, a size and a conveyance direction of a second image formed medium where image formation on the second image formed medium is conducted after image formation on a first image formed medium, whether a timing when the first image formed medium reaches a fixing section is later than a predetermined timing. The print speed control section controls, on the basis of a determination result of the print speed determination section, the timing when the first image formed medium reaches the fixing section.

### CROSS-REFERENCE TO RELATED APPLICATION

This application is based upon and claims the benefit of priority from Japanese Patent Application No. 2017-080986, filed Apr. 14, 2017, the entire contents of which are incorporated herein by reference.

### FIELD

Embodiments described herein relate generally to an image forming apparatus and an image forming method.

### BACKGROUND

Conventionally, a heat source is utilized in a fixing device of toner in an image forming apparatus. However, at the time of carrying out image formation on a sheet having a wide width a short time after carrying out the image formation on a sheet having a narrow width, image formation is carried out in a state where temperatures of both ends of a fixing belt are not completely decreased to a predetermined temperature.

### DESCRIPTION OF THE DRAWINGS

FIG. 1 is a cross-sectional view schematically illustrating an image forming apparatus according to an embodiment;

FIG. 2 is a view schematically illustrating an image forming section according to the present embodiment;

FIG. 3 is a view schematically illustrating a fixing section according to the present embodiment;

FIG. 4 is a view schematically illustrating a fixing belt according to the present embodiment;

FIG. 5 is a block diagram of the image forming apparatus according to the present embodiment;

FIG. 6 is a view illustrating temperature distribution of the fixing belt after A4R sheet fixation according to the present embodiment;

FIG. 7 is a view illustrating a relationship between a print speed and Tp-TH when an A4R sheet passes according to the present embodiment;

FIG. 8 is a view schematically illustrating a file of print waiting jobs stored in a RAM of a control section;

FIG. 9(A) is a view schematically illustrating a sheet interval in a case in which a longitudinal sheet is conveyed; and FIG. 9(B) is a schematic diagram illustrating a sheet interval in a case in which a lateral sheet and a longitudinal sheet are alternately printed;

FIG. 10 is a flowchart illustrating a process of an image forming processing of the image forming apparatus according to the present embodiment; and

FIG. 11 is a diagram illustrating a modification of FIG. 8.

### DETAILED DESCRIPTION

In accordance with an embodiment, an image forming apparatus comprises a print speed determination section and a print speed control section. The print speed determination section determines, on the basis of at least one of a shape, a size and a conveyance direction of a second image formed medium where image formation on the second image formed medium is conducted after image formation on a first image formed medium, whether a timing when the first image formed medium reaches a fixing section is later than a predetermined timing. The print speed control section controls, on the basis of a determination result of the print speed determination section, the timing when the first image formed medium reaches the fixing section.

Hereinafter, an image forming apparatus and an image forming method of an embodiment are described with reference to the accompanying drawings.

### Embodiment

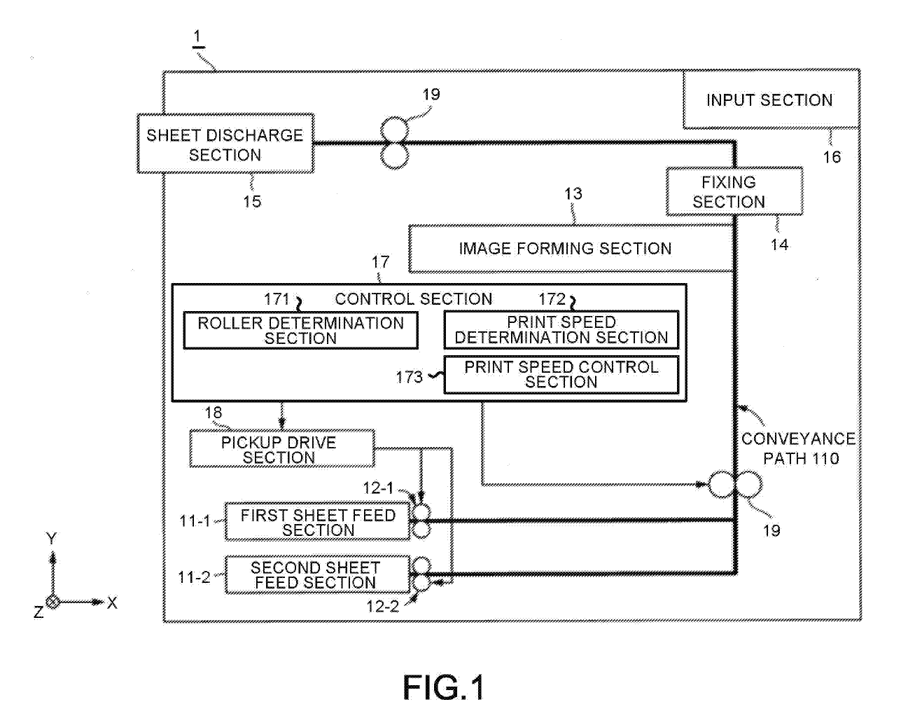

FIG. 1 is a cross-sectional view schematically illustrating an image forming apparatus according to one embodiment. An image forming apparatus 1 is provided with a first sheet feed section 11-1, a second sheet feed section 11-2, a first pickup roller 12-1, a second pickup roller 12-2, an image forming section 13, a fixing section 14, a sheet discharge section 15, an input section 16, a control section 17, a pickup drive section 18 and a roller for conveyance 19. Hereinafter, the first sheet feed section 11-1 and the second sheet feed section 11-2 are collectively referred to as a sheet feed section 11 if not distinguished, and the first pickup roller 12-1 and the second pickup roller 12-2 are collectively referred to as a pickup roller 12 if not distinguished.

A sheet is conveyed from the sheet feed section 11 of the image forming apparatus 1, via the image forming section 13 and the fixing section 14 to the sheet discharge section 15 on a conveyance path 110 shown in the figure. The sheet feed section 11 side is set to an upstream side with respect to a sheet conveyance direction, and the sheet discharge section 15 side is set to a downstream side with respect to the sheet conveyance direction. The sheet is one concrete example of an image formed medium. Hereinafter, a case in which the image formed medium is a sheet is described as an example. Furthermore, the pickup drive section 18 is one example of a pickup roller drive section.

The sheet feed section 11 has a tray. The sheet feed section 11 stacks a sheet on the tray. The sheet feed section 11 supplies a sheet to an inner part of the image forming apparatus 1 for forming an image on a sheet serving as the concrete example of the image formed medium. The sheet feed section 11 is provided with a first sheet feed section 11-1 for stacking a sheet (hereinafter, referred to as a “longitudinal sheet”, for example, A4R) of which the longitudinal direction is coincident with the conveyance direction, and a second sheet feed section 11-2 for stacking a sheet (hereinafter, referred to as a “lateral sheet”, for example, A4) of which the lateral direction is coincident with the conveyance direction. Hereinafter, the longitudinal direction is referred to as “longitudinal”, and a direction perpendicular to the longitudinal direction is referred to as “lateral”. Furthermore, the longitudinal sheet is one example of a first image formed medium, and the lateral sheet is one example of a second image formed medium. In the present embodiment, the longitudinal sheet is described as A4, and the lateral sheet is described as A4R.

The pickup roller 12 is constituted by rollers. The rollers of the pickup roller 12 are rotated by the pickup drive section 18 which operates in response to the control of the control section 17. The pickup roller 12 picks up sheets stacked on the sheet feed section 11 one by one, and feeds the picked-up sheet to an inner part of the image forming apparatus 1. The pickup roller 12 is provided with the first pickup roller 12-1 for picking up a sheet stacked on the first sheet feed section 11-1, and the second pickup roller 12-2 for picking up a sheet stacked on the second sheet feed section 11-2.

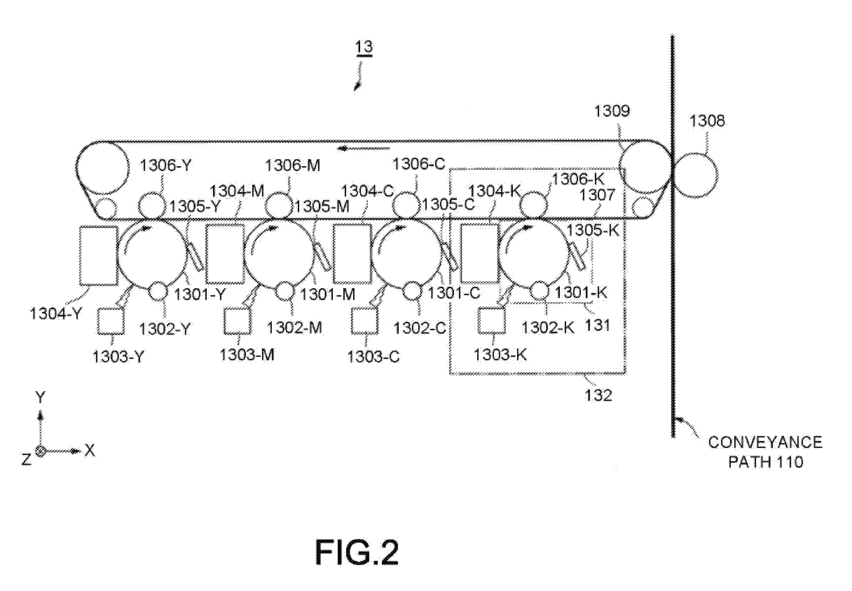

The image forming section 13 is provided with a photoconductive drum for yellow 1301-Y, a photoconductive drum for magenta 1301-M, a photoconductive for cyan drum 1301-C, a photoconductive drum for black 1301-K, a charger for yellow 1302-Y, a charger for magenta 1302-M, a charger for cyan 1302-C, a charger for black 1302-K, an exposure device for yellow 1303-Y, an exposure device for magenta 1303-M, an exposure device for cyan 1303-C, an exposure device for black 1303-K, a developing device for yellow 1304-Y, a developing device for magenta 1304-M, a developing device for cyan 1304-C, a developing device for black 1304-K, a photoconductor cleaner for yellow 1305-Y, a photoconductor cleaner for magenta 1305-M, a photoconductor cleaner for cyan 1305-C, a photoconductor cleaner for black 1305-K, a primary transfer roller for yellow 1306-Y, a primary transfer roller for magenta 1306-M, a primary transfer roller for cyan 1306-C, a primary transfer roller for black 1306-K, an intermediate transfer belt 1307, a secondary transfer roller 1308 and a secondary transfer opposite roller 1309. FIG. 2 is a diagram illustrating one concrete example of the image forming section 13. Although not shown in the figure, the image forming section 13 is provided with toner cartridges of yellow, magenta, cyan and black.

Hereinafter, the photoconductive drum for yellow 1301-Y, the photoconductive drum for magenta 1301-M, the photoconductive drum for cyan 1301-C and the photoconductive drum for black 1301-K are collectively referred to as a photoconductive drum 1301 if not distinguished respectively.

Hereinafter, the charger for yellow 1302-Y, the charger for magenta 1302-M, the charger for cyan 1302-C and the charger for black 1302-K are collectively referred to as a charger 1302 if not distinguished respectively.

Hereinafter, the exposure device for yellow 1303-Y, the exposure device for magenta 1303-M, the exposure device for cyan 1303-C and the exposure device for black 1303-K are collectively referred to as an exposure device 1303 if not distinguished respectively.

Hereinafter, the developing device for yellow 1304-Y, the developing device for magenta 1304-M, the developing device for cyan 1304-C and the developing device for black 1304-K are collectively referred to as a developing device 1304 if not distinguished respectively.

Hereinafter, the photoconductor cleaner for yellow 1305-Y, the photoconductor cleaner for magenta 1305-M, the photoconductor cleaner for cyan 1305-C and the photoconductor cleaner for black 1305-K are collectively referred to as a photoconductor cleaner 1305 if not distinguished respectively.

Hereinafter, the primary transfer roller for yellow 1306-Y, the primary transfer roller for magenta 1306-M, the primary transfer roller for cyan 1306-C and the primary transfer roller for black 1306-K are collectively referred to as a primary transfer roller 1306 if not distinguished respectively.

The image forming section 13 is provided with a cleaner unit 131 for each of the colors. The cleaner unit 131 is provided with the photoconductive drum 1301, the charger 1302 and the photoconductor cleaner 1305.

The image forming section 13 is provided with a process unit 132 for each of the colors. The process unit 132 is provided with the cleaner unit 131, the exposure device 1303, the developing device 1304 and the primary transfer roller 1306.

The photoconductive drum 1301 is an image carrier, for example, a cylindrical drum. The photoconductive drum 1301 arranges a photoconductor material on an outer peripheral surface thereof, and has a property for emitting static electricity only at a part irradiated by light. The charger 1302 is, for example, a needle electrode, and charges the surface of the photoconductive drum 1301 described above with the static electricity. The exposure device 1303 is, for example, a laser irradiation device, and forms an electrostatic latent image corresponding to image information on the surface of the main photoconductive drum described above. The developing device 1304 supplies toner to the surface of the photoconductive drum 1301, and develops the electrostatic latent image with the toner. The photoconductor cleaner 1305 removes remaining toner of the photoconductive drum 1301. The primary transfer roller 1306 transfers the electrostatic latent image developed on the surface of the photoconductive drum with the toner to the intermediate transfer belt 1307. The intermediate transfer belt is an endless belt. The secondary transfer roller 1308 transfers a toner image on the intermediate transfer belt 1307 to a supplied sheet. The secondary transfer opposite roller 1309 is a roller existing at a position opposite to the secondary transfer roller 1308 across the intermediate transfer belt 1307. The secondary transfer opposite roller 1309 sandwiches the foregoing sheet between the secondary transfer opposite roller 1309 and the secondary transfer roller 1308.

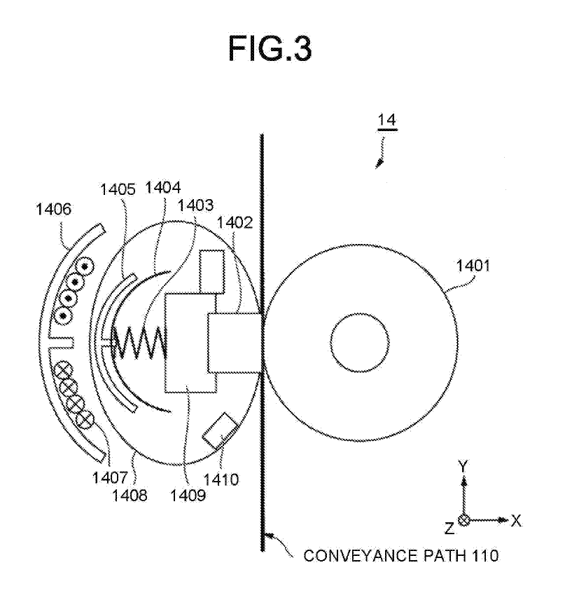

FIG. 3 is a diagram illustrating one concrete example of the fixing section 14. The fixing section 14 is provided with a pressure roller 1401, a nip pad 1402, a magnetic shunt alloy position adjustment section 1403, a shield 1404, a heat generation auxiliary plate 1405, a ferrite core 1406, a coil 1407, a fixing belt 1408, a holding member 1409 and a temperature sensor 1410.

The pressure roller 1401 includes a member made of metal as a core material, and an elastic layer such as a silicone sponge and a silicone rubber layer on an outer side thereof. The pressure roller 1401 has a release layer on the surface thereof. The pressure roller 1401 may be rotated to cause the fixing belt 1408 to follow. The pressure roller may be provided with a one-way clutch mechanism.

The nip pad 1402 is formed of a heat resistant resin. The heat resistant resin is, for example, polyether ether ketone (PEEK) or phenolic resin. The nip pad 1402 exists on an inner side of the fixing belt 1408, and presses the fixing belt 1408 against the pressure roller 1401 side. A nip is formed between the fixing belt 1408 and the pressure roller 1401. The nip pad 1402 is fixed to the holding member 1409. A width of the nip pad 1402 (length in a z axis direction in FIG. 3) is wider than that of a sheet to be conveyed by the conveyance path 110. The nip pad 1402 is provided with a low friction sheet (not shown) between the nip pad 1402 and the pressure roller 1401 in order to achieve a good sliding property.

The magnetic shunt alloy position adjustment section 1403 is a position adjustment section of the heat generation auxiliary plate 1405, and is provided with a spring. The magnetic shunt alloy position adjustment section 1403 is fixed to the holding member 1409, and adjusts the position of the heat generation auxiliary plate 1405 through force of the spring.

The shield 1404 shields a magnetic flux formed by currents flowing to the coil 1407. The shield 1404 is formed of for example, a nonmagnetic material such as aluminum or copper. The shield 1404 suppress that the magnetic flux is affected by the temperature sensor 1410 and the like.

The heat generation auxiliary plate 1405 is formed of a thin metal member made of a magnetic shunt alloy such as iron, nickel alloy and the like of which the Curie point is 220 degrees centigrade-230 degrees centigrade. A magnetic permeability of the metal is reduced and a magnetic flux density thereof penetrating through the fixing belt 1408 is decreased if the temperature of the heat generation auxiliary plate 1405 excesses the Curie point. Thus, if the temperature of the heat generation auxiliary plate 1405 excesses the Curie point, an amount of heating to the fixing belt 1408 by the heat generation auxiliary plate 1405 is decreased. Thus, temperature increase of both ends of the fixing belt 1408 is suppressed.

The ferrite core 1406 suppress that the magnetic flux formed by currents flowing to the coil 1407 leaks in a direction in which the fixing belt 1408 does not exist (in a direction towards the negative Y axis). The ferrite core 1406 forces the magnetic flux on the fixing belt 1408.

The coil 1407 is a conductive coil. The coil 1407 forms a magnetic field by the flow of AC currents. In FIG. 3, a cross section of the coil 1407 is shown. The currents flow within the cross section shown in FIG. 3 in the Z axis direction.

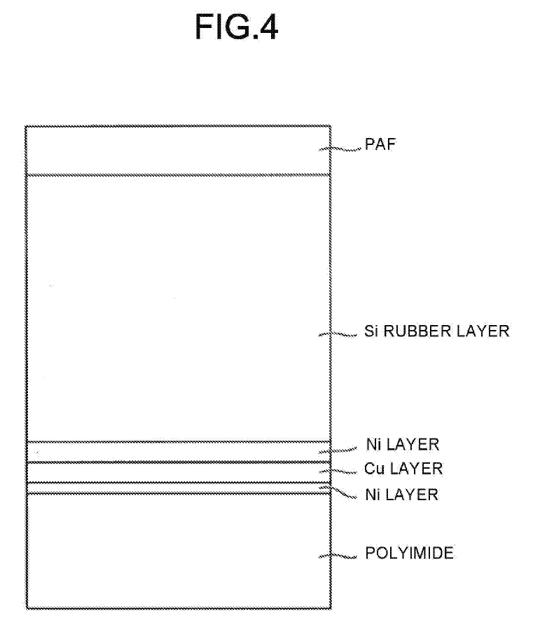

The fixing belt 1408 is an endless belt. The fixing belt 1408 has a plurality of layers. The fixing belt 1408 is provided with a layer (hereinafter, referred to as a “conductive layer”) which generates heat by the magnetic field formed by the coil 1407. The conductive layer is formed of a conductive material such as iron, nickel, copper and the like. FIG. 4 is a diagram illustrating one concrete example of the fixing belt 1408. The fixing belt 1408 is a structure in which a polyimide sleeve of 70 μm is set to a base material and a Ni layer of 1 μm, a Cu layer of 10 μm, a Ni layer of 8 μm, a Si rubber layer of 200 μm, and a layer (toner release layer) having tetrafluoroethylene/perfluoroalkyl vinyl ether copolymer resin (PFA) of 30 μm are sequentially laminated from the bottom to the top. A length of a lateral width of the fixing belt 1408 (in other words, in a direction perpendicular to a rotation direction of the fixing belt 1408) is the longest length of the lateral width among all sheets expected to be used by the image forming apparatus 1. Therefore, for example, in a case in which only sheets having the same size are used, the lateral width of the fixing belt 1408 is a length matching the lateral width of the lateral sheet having the foregoing size.

The holding member 1409 holds the nip pad 1402. The holding member 1409 exists in an inner side of the fixing belt 1408.

The temperature sensor 1410 exists on an inner side of the fixing belt, and detects the temperature of the fixing belt 1408. The fixing belt 1408 may be a contact type temperature sensor or a non-contact type temperature sensor. The temperature sensor 1410 measures the temperature of a central part of the lateral width of the fixing belt 1408. Further, an arrangement of the temperature sensor 1410 is not limited to the foregoing arrangement as long as it may be an arrangement capable of measuring a desired temperature.

The fixing section 14 may be further provided with a thermostat (not shown) in an inner side of the fixing belt 1408.

Return to the description of FIG. 1.

The sheet discharge section 15 is constituted by rollers. The rollers of the sheet discharge section 15 are rotated by a sheet discharge drive section 15a which operates depending to the control of the control section 17. The sheet discharge section 15 moves a non-image formed medium towards the conveyance direction by the rotation of the rollers. The sheet discharge section 15 moves a sheet with an image fixed on the surface thereof by the fixing section 14 towards the conveyance direction to discharge the sheet to an external device of the image forming apparatus 1.

The input section 16 is an operation panel having a user interface. The operation panel is arranged on a front side of an upper part of a main body of the image forming apparatus 1 and has a display section including various well-known input buttons and a touch panel. Further, the input section 16 may be an interface for connecting an existing input device such as a personal computer to the image forming apparatus 1.

Information necessary for image formation is input via the input section 16. The information necessary for image formation is information such as either monochrome printing or color printing on a sheet to be printed, a size of a sheet to be used or a sheet feed cassette to be used, the number of sheets to be printed, the number of copies to be printed and the like.

Furthermore, an alternate printing mode is input via the input section 16. In a case in which the alternate printing mode is input via the operation panel, an alternate printing mode button is pressed. In a case in which the alternate printing mode is input from a personal computer, a command of the alternate printing mode is included in a print command. Furthermore, the alternate printing is used for switching a sheet for image formation between the longitudinal sheet (for example, A4R) and the lateral sheet (A4) in copy. Furthermore, hereinafter, a case of printing only on the longitudinal sheet is referred to as “longitudinal printing”, and a case of printing only on the lateral sheet is referred to as “lateral printing”.

The control section 17 constituted by a CPU, a ROM and a RAM is provided with a roller determination section 171, a print speed determination section 172 and a print speed control section 173. The roller determination section 171 determines a pickup roller to be driven on the basis of input sheet associated information. If acquiring information for instructing use of the longitudinal sheet, the roller determination section 171 selects to choose the first pickup roller. If acquiring information for instructing use of the lateral sheet, the roller determination section 171 selects to choose the second pickup roller.

The print speed determination section 172 determines a print speed on the basis of the input sheet associated information. The print speed is a value indicating a timing at which a next sheet continuously processed reaches the fixing section 14. For example, based on a time at which the processing of the fixing section 14 on the previous sheet is ended, the print speed is a value indicating a timing at which the next sheet reaches the fixing section 14. The print speed may be a speed determined by one or both of a timing (hereinafter, referred to as a “pickup timing”) at which a sheet is picked up and a speed (hereinafter, referred to as a “conveyance speed”) at which a sheet is conveyed. For example, if the pickup timing is later than a predetermined timing and the conveyance speed is a predetermined speed, the print speed is slow. In a case of next pickup for picking up, for example, the longitudinal sheet, the print speed determination section 172 determines to carry out the pickup at a time interval with respect to a reference time. In a case of next pickup for picking up the lateral sheet, the print speed determination section 172 determines to carry out the pickup after the reference time.

The print speed control section 173 controls the print speed by controlling the pickup drive section 18 or the roller for conveyance 19 on the basis of a determination result of the print speed determination section 172.

The control section 17 further controls each function of the image forming apparatus 1.

The pickup drive section 18 drives a pickup roller on the basis of the selection of the control section 17. The pickup drive section 18 is a drive device such as a motor. The pickup drive section 18 rotates the pickup roller 12 by receiving supply of power to generate driving force. The pickup drive section 18 drives the first pickup roller in a case in which the selection of the control section 17 is the selection for driving the first pickup roller. The pickup drive section 18 drives the second pickup roller in a case in which the selection of the control section 17 is the selection for driving the second pickup roller. Further, the pickup drive section 18 is controlled by the print speed control section 173 to drive the pickup roller 12 at a timing based on the determination result of the print speed determination section 172. The pickup drive section 18 requires time T_{K} of switching (hereinafter, referred to as “cassette switching”) in a case of driving the second pickup roller after driving the first pickup roller and in a case of driving the first pickup roller after driving the second pickup roller.

The roller for conveyance 19 is constituted by rollers. The roller for conveyance 19 conveys a sheet along the conveyance path 110. A rotation speed of the roller for conveyance 19 is controlled by the print speed control section 173 to realize the conveyance speed based on the determination result of the print speed determination section 172.

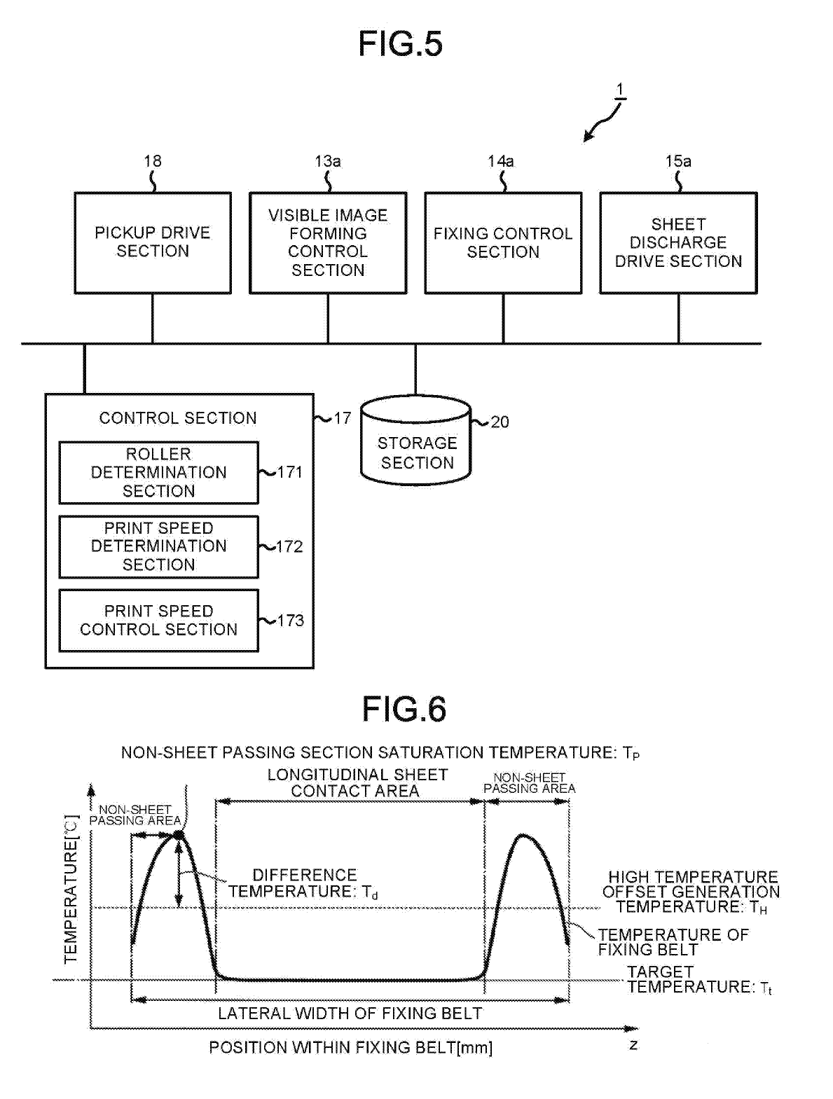

FIG. 5 is a schematic block diagram illustrating functional components of the image forming apparatus 1. The image forming apparatus 1 is provided with the control section 17, the pickup drive section 18, an image forming control section 13a, a fixing control section 14a, a sheet discharge drive section 15a and a storage section 20. The control section 17 and the pickup drive section 18 are the same as the above, and thus not described. The image forming control section 13a controls operations of the visible image forming section 13 depending on the control of the control section 17. The fixing control section 14a controls operations of the fixing section 14 depending on the control of the control section 17. The sheet discharge drive section 15a is a drive device such as a motor. The sheet discharge drive section 15a rotates a sheet discharge roller of the sheet discharge section 15 by receiving the supply of the power to generate the driving force. The control section 17 controls operations of each functional section connected via a bus by operating on the basis of a predetermined program. The storage section 20 is constituted by a storage device such as a magnetic hard disk device or a semiconductor storage device. The storage section 20 stores data such as the sheet associated information input by the input section 16.

FIG. 6 is a diagram illustrating temperature distribution of the fixing belt 1408 immediately after the image formation on the longitudinal sheet is completed in the image forming apparatus 1 which assumes that the image formation is carried out on the longitudinal sheet and the lateral sheet having the same size. The horizontal axis of FIG. 6 indicates a position of the fixing belt in a direction perpendicular to the rotation direction. The vertical axis of FIG. 6 indicates a temperature. A target temperature Tₜ is a temperature set at the time of fixation of toner and is a temperature at which the fixation of the toner is possible. A high temperature offset generation temperature T_{H} is a temperature at which the toner is offset if it is greater than or equal to this temperature. A non-sheet passing section saturation temperature Tₚ is the highest temperature of the fixing belt 1408. A difference temperature T_{d} is a temperature of a difference between the non-sheet passing section saturation temperature Tₚ and the high temperature offset generation temperature T_{H}.

In FIG. 6, in an area (hereinafter, referred to as a “non-sheet passing area”) where the fixing belt 1408 does not come into contact with the longitudinal sheet, the temperature of the fixing belt 1408 is increased and becomes a temperature greater than or equal to the high temperature offset generation temperature T_{H}. This is generated because at the time of the image formation, the sheet does not come into contact with the fixing belt, and absorption of heat by the sheet does not occur. On the other hand, in an area (hereinafter, referred to as a “longitudinal sheet contact area”) where the fixing belt 1408 comes into contact with the longitudinal sheet, since the heat is taken by the sheet, the temperature becomes the target temperature Tt. In a state of the temperature distribution shown in FIG. 6, next, in a case in which the image formation of the lateral sheet is carried out, since the width of the lateral sheet is wider than that of the longitudinal sheet, part of the image formation is carried out in an area where the temperature reaches the high temperature offset generation temperature T_{H}. In this case, no desired image is formed.

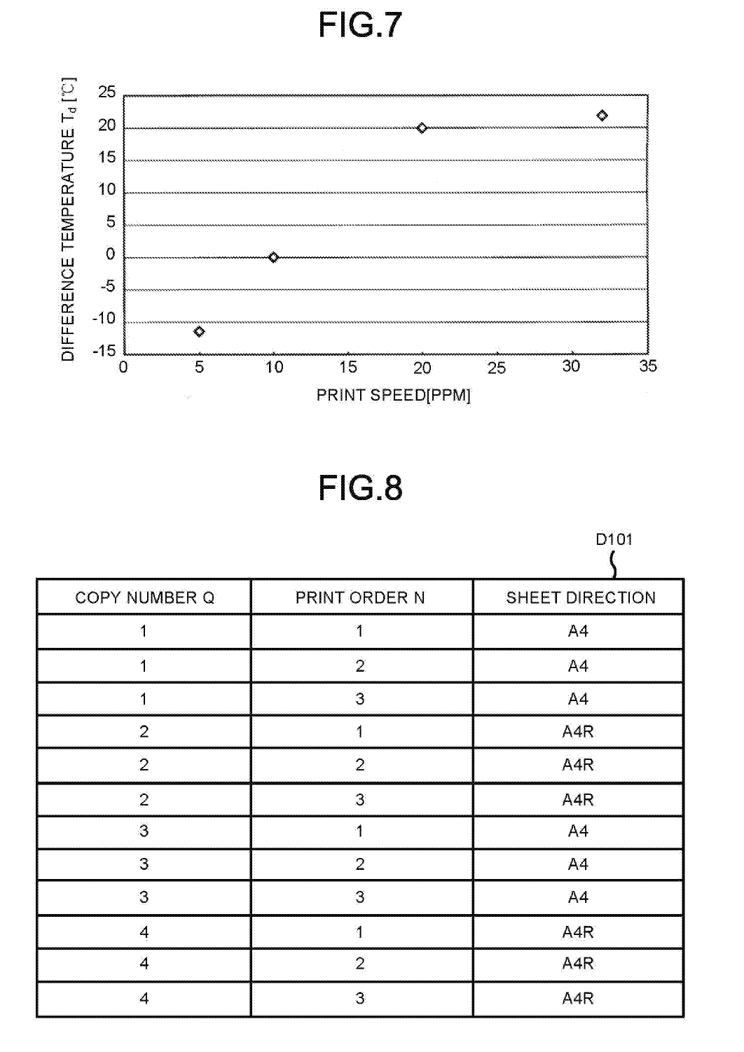

FIG. 7 is a diagram illustrating one concrete example of a relationship between a print speed and Tp-TH when the A4R passes.

In the image formation on the second sheet, the quicker the print speed is, the higher the difference temperature T_{d} becomes since the image formation in a state where the temperature of the non-sheet passing area increased at the time of the image formation of the first sheet is not decreased is carried out. For example, if the print speed is 20 PPM (Print Per Minutes), the difference temperature T_{d} is 20 degrees centigrade.

Furthermore, even when the image is not formed, the minimum heating for maintaining the apparatus is carried out on the fixing belt 1408. At the time of the image formation, the heating is carried out such that the temperature measured by the temperature sensor 1410 reaches the target temperature Tₜ.

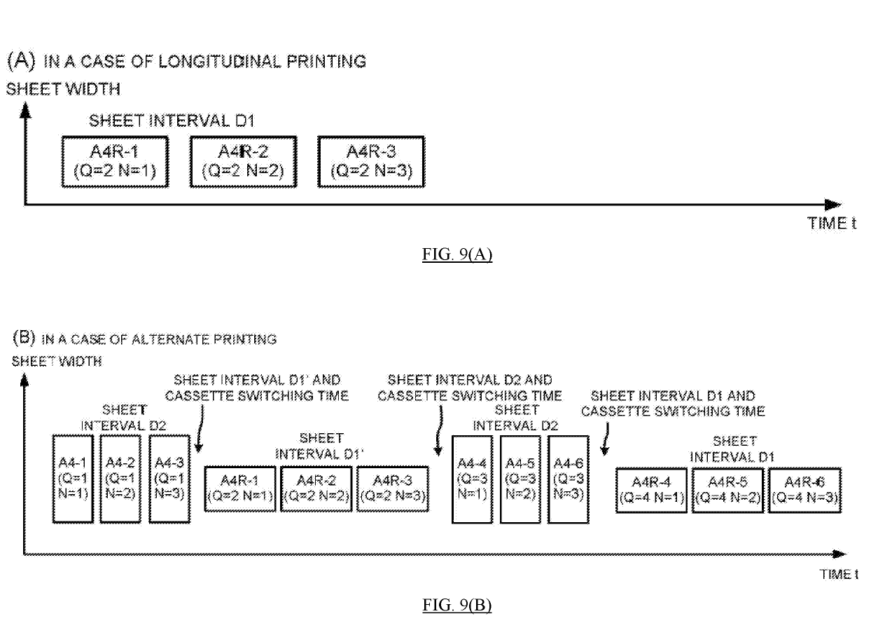

FIG. 8 is a view schematically illustrating a file of print waiting jobs stored in the RAM of the control section. The print waiting jobs stored in the RAM are classified into a copy number Q and a print order N and a sheet type corresponding to the copy number Q. The copy number Q is a number indicating the number of a copy to be printed in a case of printing an image in unit. The print order N is the order of printing of an image in each copy. The sheet type indicates the type of a sheet to be used for printing in a copy. In the present embodiment, A4 and A4R are used. Furthermore, the A4 sheet is the lateral sheet, and the A4R sheet is the longitudinal sheet.

In the print waiting jobs stored in the RAM in FIG. 8, the image formation in copy is carried out, and the types of the sheets are changed alternately in copy. In other words, the input section 16 receives the command of the alternate printing. For example, in the image formation in which the copy number Q is 1, the image is formed on the lateral sheet (A4), and in the image formation in which the copy number Q is 2, the image is formed on the longitudinal sheet (A4R). In FIG. 8, after the image is formed on the lateral sheet in the image formation in which the copy number Q is 1 and the print order N is 3, the image is formed on the longitudinal sheet in the image formation in which the copy number Q is 2 and the print order N is 1. Hereinafter, the image formation in which the copy number Q is instructed by a and the print order N is instructed by b in the sheet associated information is recorded as (a, b). a and b are integers.

FIG. 9 (A) is a view schematically illustrating a sheet interval in a case in which the longitudinal sheet is conveyed, and FIG. 9 (B) is a schematic diagram illustrating a sheet interval in a case in which the lateral sheet and the longitudinal sheet are alternately printed.

The horizontal axes of graphs of FIG. 9(A) and FIG. 9(B) indicate time, and the vertical axes indicate the lateral width of the sheet. Furthermore, since the horizontal axes are time in the graphs of FIG. 9, time represented by a sheet interval of FIG. 9 is time at which the sheet is conveyed by a distance between sheet intervals.

In FIG. 9, A4R indicates the longitudinal sheet, and A4 indicates the lateral sheet. One of a sheet interval D1, a sheet interval D2 and a sheet interval D1′ indicates a distance between sheets. For example, in FIG. 9 (A), after a sheet A4R-1 is ended, the image formation of a sheet A4R-2 is started across the sheet interval D1. A relationship between the sheet interval D1 and the sheet interval D1′ is D1<D1′. FIG. 9 (A) indicates a state in which the sheet passes through one predetermined point on the conveyance path 110 in a case of the longitudinal printing and indicates the horizontal axis as the time axis. The distance between sheets is the sheet interval D1. FIG. 9 (B) indicates a state in which the sheet passes through one predetermined point on the conveyance path 110 in a case in which the image forming apparatus 1 storing the print waiting jobs shown in FIG. 8 carries out the alternate printing and indicates the horizontal axis is the time axis. The sheet interval between a sheet A4-1 and a sheet A4-2, the sheet interval between the sheet A4-2 and a sheet A4-3, the sheet interval between a sheet A4-4 and a sheet A4-5, and the sheet interval between the sheet A4-5 and a sheet A4-6 are the sheet interval D2. In other words, the sheet interval D2 indicates the sheet interval between the lateral sheets. The sheet interval between the sheet interval between the sheet A4R-1 and the sheet A4R-2 and the sheet interval between the sheet A4R-2 and a sheet A4R-3 is the sheet interval D1′. The sheet interval between the sheet A4R-4 and a sheet A4R-5 and the sheet interval between the sheet A4R-5 and the sheet A4R-6 are D1. When the type of the sheet is changed, time indicated by the sheet interval and time of cassette switching are required. Thus, for example, in a case in which the sheet A4R-1 is printed after the sheet A4-3, time between the sheet A4-3 and the sheet A4R-1 becomes total time of the sheet interval D1′ and the cassette switching time. The distance between sheets when the type of the sheet is changed is the sheet interval between sheets after type change (in other words, A4R sheets in the foregoing example).

Since the sheet A4R-1 is a sheet having a narrow width, the temperature of the non-sheet passing area becomes higher than that at the time of the image formation on the sheet A4. Thus, at the time of the alternate printing in which the image formation on the non-sheet passing area by the lateral sheet is carried out, the sheet interval D1′ serving as a sheet interval wider than that in a case of the longitudinal printing becomes a sheet interval between the longitudinal sheets such that the temperature of the non-sheet passing area does not become greater than or equal to the predetermined temperature. Furthermore, in the image formation in which the copy number Q is the last, the sheet interval is not widened such that the sheet interval of the image formation in which the copy number Q in FIG. 9 (B) is 4 is D1.

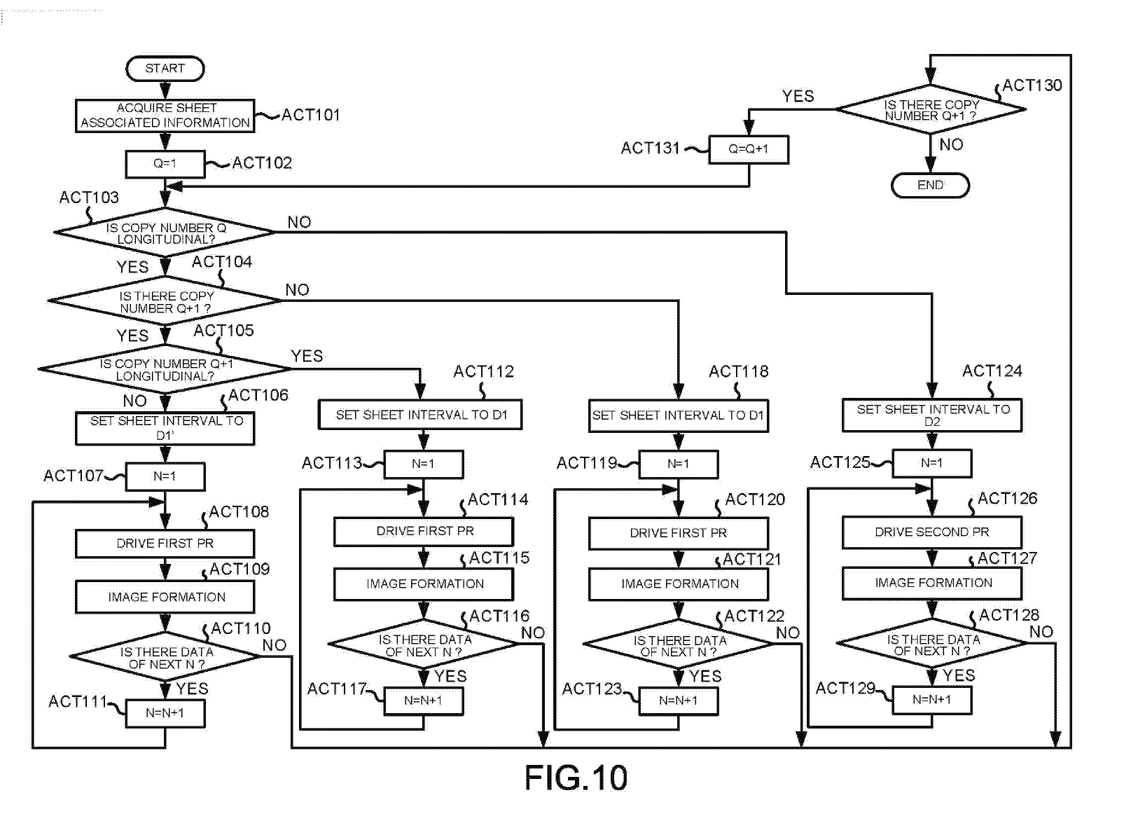

FIG. 10 is a flowchart illustrating a process of an image forming processing of the image forming apparatus 1. Furthermore, the pickup roller is recorded as PR in the figure. Further, FIG. 10 illustrates a case in which information for instructing the alternate printing is input. Information relating to printing is input via the input section 16. The input information is stored in the RAM of the control section 17. The information of the print waiting jobs is stored in the file formed in the RAM as shown in FIG. 8 (ACT 101). The control section 17 acquires information of a table of the copy number Q=1 in the file stored in the RAM (ACT 102). The roller determination section 171 determines whether or not the image formation of the copy number Q is carried out on the longitudinal sheet (ACT 103). If the image formation of the copy number Q is carried out on the longitudinal sheet (Yes in ACT 103), the control section 17 determines whether or not there is data (in other words, data of the Q+1th copy) in which the copy number Q is the next number which indicates the acquired sheet associated information described above (ACT 104). If there is the data (Yes in ACT 104), the print speed determination section 172 determines whether or not the image formation of the copy number Q+1 is carried out on the longitudinal sheet (ACT 105). If the image formation of the copy number Q+1 is carried out on the lateral sheet (No in ACT 105), the print speed determination section 172 sends an instruction for carrying out control for setting the sheet interval to D1′ to the print speed control section 173 (ACT 106). Next, the control section 17 acquires information of a table of the print order N=1 (ACT 107). The pickup drive section 18 drives the first pickup roller such that the sheet interval is the sheet interval D1′ on the basis of the determination result of the roller determination section 171 in ACT 103 and the instruction of ACT 106 (ACT 108). An image is formed on a picked up sheet (ACT 109). Next, the control section 17 determines whether or not there is data of next N (in other words, data of N=N+1) (ACT 110). If there is the data (Yes in ACT 110), the control section 17 returns to the processing in ACT 107 after acquiring the data of N=N+1 (ACT 111). In the determination of ACT 110, if there is no data of N=N+1 (No in ACT 110), the control section 17 determines whether or not there is data in which the copy number Q is Q+1 (ACT 130). If there is no data (No in ACT 130), the image forming apparatus 1 ends the processing. If there is the data (Yes in ACT 130), the control section 17 acquires the data of Q=Q+1 (ACT 131). After that, the control section 17 returns to the processing in ACT 103. In the determination of ACT 105, if the image formation of the copy number Q+1 is carried out on the longitudinal sheet (Yes in ACT 105), the print speed determination section 172 sends an instruction for carrying out control for setting the sheet interval to D1 to the print speed control section 173 (ACT 112). Next, the control section 17 acquires the information of the table of the print order N=1 (ACT 113). The pickup drive section 18 drives the first pickup roller such that the sheet interval is the sheet interval D1 on the basis of the determination result of the roller determination section 171 in ACT 103 and the instruction of ACT 112 (ACT 114). An image is formed on a picked up sheet (ACT 115). Next, the control section 17 determines whether or not there is data of next N (in other words, data of N=N+1) (ACT 116). If there is the data (Yes in ACT 116), the control section 17 returns to the processing in ACT 107 after acquiring the data of N=N+1 (ACT 117). In the determination of ACT 116, if there is no data of N=N+1 (No in ACT 116), the image forming apparatus 1 proceeds to the processing in ACT 130. In the determination of ACT 104, if it is determined that there is no data of the copy number Q=Q+1 (No in ACT 104), the print speed determination section 172 sends an instruction for carrying out control for setting the sheet interval to D1 to the print speed control section 173 (ACT 118). Next, the control section 17 acquires the information of the table of the print order N=1 (ACT 119). The pickup drive section 18 drives the first pickup roller 12-1 such that the sheet interval is the sheet interval D1 on the basis of the determination result of the roller determination section 171 in ACT 103 and the instruction of ACT 118 (ACT 120). An image is formed on a picked up sheet (ACT 121). Next, the control section 17 determines whether or not there is data of next N (in other words, data of N=N+1) (ACT 122). If there is the data (Yes in ACT 122), the control section 17 returns to the processing in ACT 120 after acquiring the data of N=N+1 (ACT 123). In the determination of ACT 122, if there is no data of N=N+1 (No in ACT 122), the image forming apparatus 1 proceeds to the processing in ACT 130. In the determination of ACT 103, if the image formation of the copy number Q is carried out on the lateral sheet (No in ACT 103), the print speed determination section 172 sends an instruction for carrying out control for setting the sheet interval to D2 to the print speed control section 173 (ACT 124). Next, the control section 17 acquires information of a table of the print order N=1 (ACT 125). The pickup drive section 18 drives the second pickup roller 12-2 such that the sheet interval is the sheet interval D2 on the basis of the determination result of the roller determination section 171 in ACT 103 and the instruction of ACT 124 (ACT 126). An image is formed on a picked up sheet (ACT 127). Next, the control section 17 determines whether or not there is data of next N (in other words, data of N=N+1) (ACT 128). If there is the data (Yes in ACT 128), the control section 17 returns to the processing in ACT 126 after acquiring the data of N=N+1 (ACT 129). In the determination of ACT 128, if there is no data of N=N+1 (No in ACT 128), the image forming apparatus 1 proceeds to the processing in ACT 130.

According to the embodiment described above, by changing the conveyance timing of the sheet to the fixing section 14 according to the type of the previous sheet, the image formation for suppressing the increase of the temperature of the non-sheet passing area of the fixing belt 1408 is possible. Specifically, it is described as follows. In the image forming apparatus 1 in which the image formation is carried out on the longitudinal sheet and the lateral sheet having the same size, if the image formation on the longitudinal sheet is carried out, the temperature of the non-sheet passing area of the fixing belt 1408 is increased compared with a sheet passing area. The reason is that the heat at the time of the fixation of the toner is accumulated on the fixing belt without being taken by the sheet. Thus, if the image formation is carried out on a plurality of sheets in a short time, in the next image formation in which the image formation on the longitudinal sheet is carried out, an area appears where the fixation of the toner by the temperature greater than or equal to the predetermined temperature is carried out. Therefore, if the timing of the next image formation in which the image formation on the longitudinal sheet is carried out is slow, the image formation in a state where the heat is decreased becomes possible. The image forming apparatus 1 of the present embodiment is provided with the print speed determination section 172. In a case in which images are sequentially formed on the plurality of sheets, the print speed determination section 172 determines the timing of the conveyance of the sheet on which the image is to be formed from now on the basis of the size of the sheet immediately before the image formation is carried out and the direction. The print speed determination section 172 determines that the sheet is fed at a timing later than the reference timing in a case in which the lateral width of the sheet on which the image is to be formed from now is longer than that of the previous sheet (in other words, the length in the direction perpendicular to the conveyance direction). Thus, it is possible to form images on the plurality of sheets sequentially at a temperature in which the temperature of the non-sheet passing area is smaller than or equal to the high temperature offset generation temperature T_{H}.

(Modification)

If acquiring the information for instructing the lateral printing continuously after acquiring the information for instructing the longitudinal printing, even if the input section 16 does not acquire the information for instructing the alternate printing, the sheet interval between the longitudinal sheets may become the sheet interval D1′.

A method for the image forming apparatus 1 to suppress the increase of the temperature of the non-sheet passing area and to carry out the image formation is not a method based on the control of the sheet interval by the pickup roller 12, and may be a method based on the control of the conveyance speed by the roller for conveyance 19. In this case, since the heating to the fixing belt 1408 is carried out after elapse of time, the increase of the temperature of the non-sheet passing area is suppressed.

In several embodiments of the present invention, the alternate printing is described as an example; however, the present invention is not limited to the alternate printing. For example, in a case of printing of one copy, two copies, three copies, four copies, . . . , multiple copies, in a case in which the width of the sheet printed on the second copy with respect to the belt is compared with the width of the sheet printed on the third copy with respect to the belt, if the width of the sheet printed on the third copy with respect to the belt is larger, the conveyance speed of the sheet of the second copy is decreased than usual, or the printing is carried out by widening the sheet interval. In this way, when the sheet of the third copy having a larger sheet width than the second copy is fixed by the fixing device, it is possible to suppress unevenness of the temperature of the fixing device.

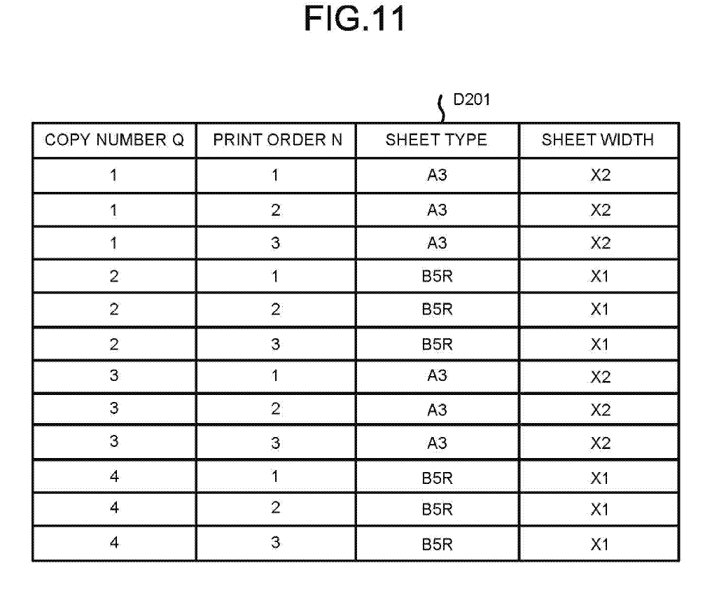

For example, the file stored in the RAM as shown in FIG. 8 may be as shown in FIG. 11. In other words, in correspondence with the copy number Q, the print order N and the size of the sheet width corresponding to the sheet type are stored. A relationship between sizes X1 and X2 of the sheet width stored in FIG. 11 is X2>X1.

Then, in a case in which the type of the sheet of which the sheet width with respect to the belt is widened compared with the sheet widths stored in the RAM is selected at the time of printing, by widening the sheet interval than usual to print, it is possible to suppress the unevenness of the temperature of the fixing device when the sheet having the large sheet width is conveyed. For example, the sheet interval in a case in which only B5R is conveyed is set to D1. Then, before printing B5R of the second copy, if the control section compares a sheet width X1 of B5R of the second copy with a sheet width X2 of A3 of the third copy and determines X2>X1, the sheet is conveyed by the sheet interval between B5Rs at D1′ wider than D1. The timing at which the sheet is picked up by the pickup roller may be slow in order to widen the sheet interval. Further, the output of the motor for driving the conveyance roller which conveys the sheet may be controlled and the sheet conveyance speed may be decreased without widening the sheet interval.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a print speed determination section configured to determine, on the basis of at least one of a shape, a size and a conveyance direction of a second image formed medium where image formation on the second image formed medium is conducted after image formation on a first image formed medium, whether a timing when the first image formed medium reaches a fixing section is later than a predetermined timing; and
a print speed control section configured to control, on the basis of a determination result of the print speed determination section, the timing when the first image formed medium reaches the fixing section.

2. The image forming apparatus according to claim 1, wherein the print speed control section is further configured to control, on the basis of the determination result of the print speed determination section, one or both of (a) a timing of feeding of the first image formed medium to be later than the predetermined timing and (b) slowing a conveyance speed of the first image formed medium.

3. The image forming apparatus according to claim 1, wherein the print speed determination section is further configured to determine whether the timing when the first image formed medium reaches the fixing section is later than the predetermined timing such that: forming an image on the second image formed medium, having a length in a direction perpendicular to the conveyance direction being longer than a length in a lateral direction of the first image formed medium, is after image formation on the first image formed medium conveyed in a direction where the longitudinal direction is coincident with the conveyance direction.

4. The image forming apparatus according to claim 2, wherein the print speed determination section is further configured to determine whether the timing when the first image formed medium reaches the fixing section is later than the predetermined timing such that: forming an image on the second image formed medium, having a length in a direction perpendicular to the conveyance direction being longer than a length in a lateral direction of the first image formed medium, is after image formation on the first image formed medium conveyed in a direction where the longitudinal direction is coincident with the conveyance direction.

5. An image forming method, including:
determining, on the basis of at least one of a shape, a size and a conveyance direction of a second image formed medium where image formation on the second image formed medium is conducted after image formation on a first image formed medium, whether a timing when the first image formed medium reaches a fixing section is later than a predetermined timing; and
controlling, on the basis of a determination result of the determining step, the timing when the first image formed medium reaches the fixing section.

6. The image forming method according to claim 5, further comprising:
controlling, on the basis of the determination result of the determining step, one or both of (a) a timing of feeding of the first image formed medium to be later than the predetermined timing and (b) slowing a conveyance speed of the first image formed medium.

7. The image forming method according to claim 5, further comprising:
determining whether the timing when the first image formed medium reaches the fixing section is later than the predetermined timing such that: forming an image on the second image formed medium, having a length in a direction perpendicular to the conveyance direction being longer than a length in a lateral direction of the first image formed medium, is after image formation on the first image formed medium conveyed in a direction where the longitudinal direction is coincident with the conveyance direction.

8. The image forming method according to claim 6, further comprising:
determining whether the timing when the first image formed medium reaches the fixing section is later than the predetermined timing such that: forming an image on the second image formed medium, having a length in a direction perpendicular to the conveyance direction being longer than a length in a lateral direction of the first image formed medium, is after image formation on the first image formed medium conveyed in a direction where the longitudinal direction is coincident with the conveyance direction.

9. An image forming apparatus, comprising:
a sheet feed section;
a pickup roller;
an image forming section;
a fixing section;
a sheet discharge section;
an input section;
a control section;
a pickup drive section; and
a roller for conveyance,
wherein the image forming section comprises:
a photoconductive drum configured to arrange a photoconductor material on an outer peripheral surface thereof;
a charger configured to charge the outer periphery surface of the photoconductive drum with static electricity;
an exposure device configured to form an electrostatic latent image on the outer periphery surface of the photoconductive drum;
a developing device configured to supply toner to the outer periphery surface of the photoconductive drum and develop the electrostatic latent image with the toner;
a photoconductor cleaner configured to remove remaining toner from the outer periphery surface of the photoconductive drum,
wherein a primary transfer roller is configured to transfer the electrostatic latent image developed on the outer periphery surface of the photoconductive drum to an intermediate transfer belt, and
wherein a secondary transfer roller transfers the electrostatic latent image to a sheet.
